(19) United States
(12) Patent Application Publication
(10) Pub. No.: US 2005/0252478 A1
(43) Pub. Date: Nov. 17, 2005

(54) Billet steel main cap girdle

(76) Inventor: Shu Woody Hwang, Baldwin Park, CA (US)

Correspondence Address: Shu Woody Hwang, 345 Cloverleaf Drive, # C, Baldwin Park, CA, 91706, US

(21) Appl. No.: 10/893,693

(22) Filed: Apr. 23, 2004

(51) Int. Cl. F02B 75/04

(52) U.S. Cl. 123/195 H; 123/48 R

(57) ABSTRACT

A recess with 0.25″ deep on all cross frames between main bolt holes is invented by the undersigned and machined during production for allowing establish and maintain an air gap between main cap top and cross frames of main girdle. This air gap is very important for avoiding directly cylinder explosion impact force transmitted from main cap top to main girdle instead of through main bolts to main cap girdle. The present design is using insertion of heavier washers under main girdle to build the air gap. However, the heavier washers have potential to build up concentrated stress spot.

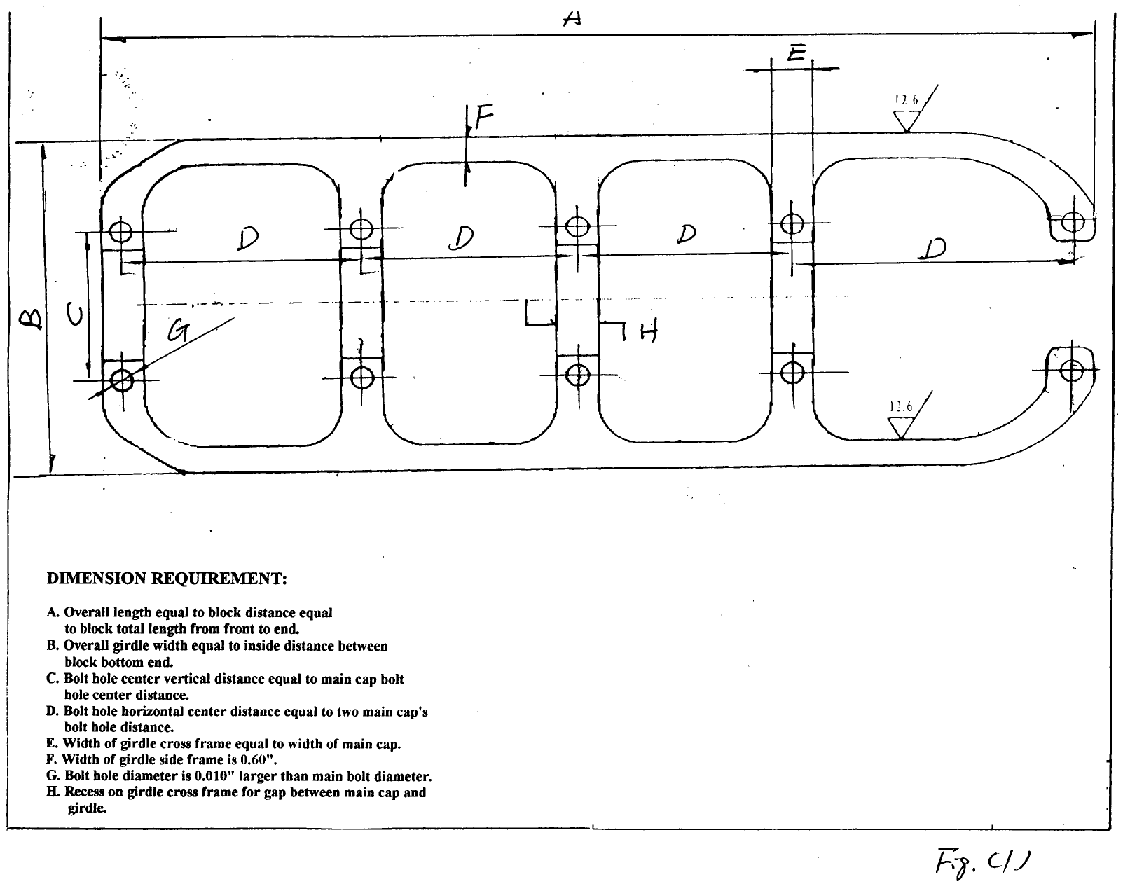

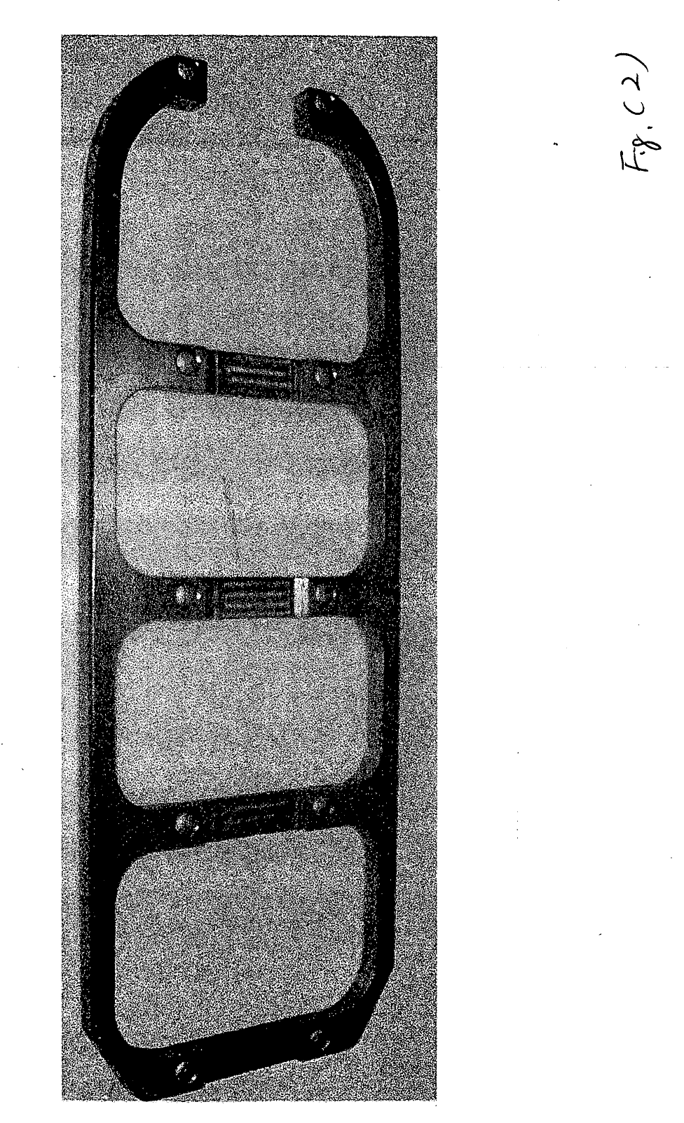

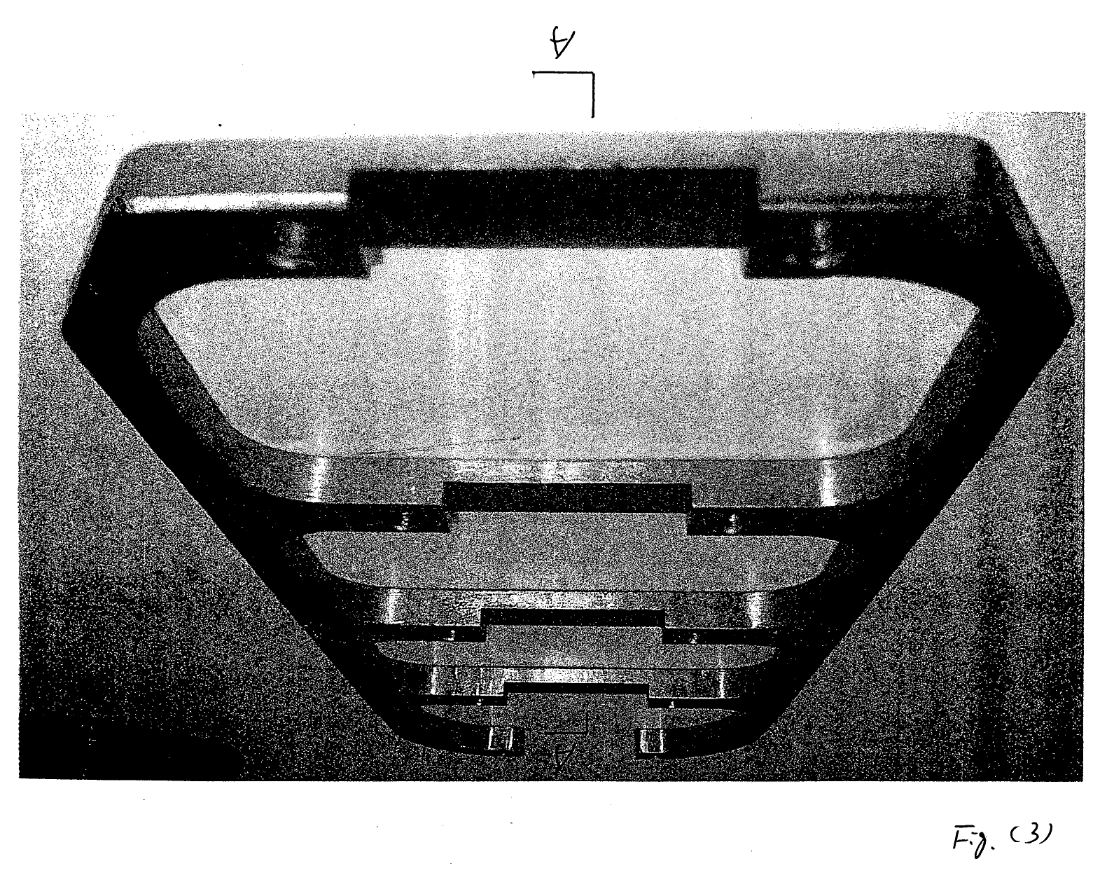

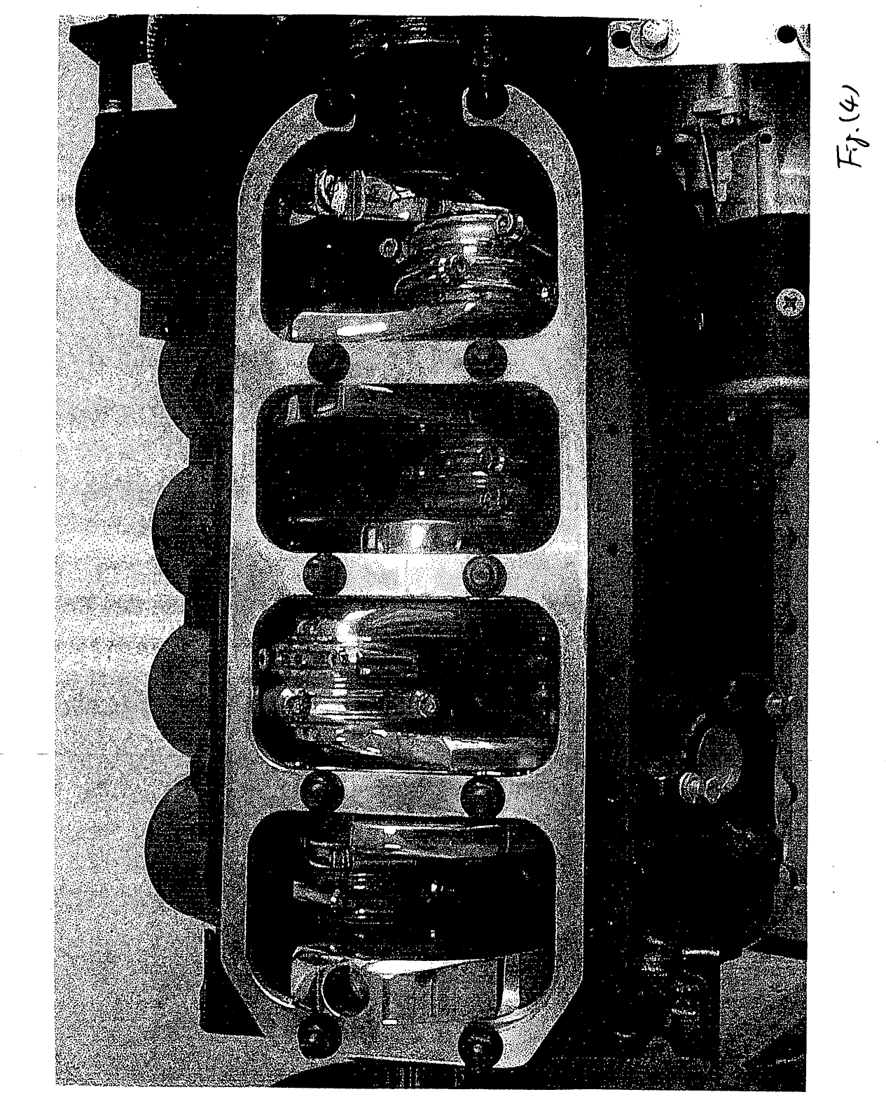

On today's market, to solve the problem of increasing horesepowrer and working load for a muscle car or racing engine is the major target of after market trend.

It is easier for increasing engine RPM and torque for replacing of forged steel crank, lighter pistons, stronger connecting rods, heavy duty rocker arms, etc. But muscle up the existing engine to match the increasing horsepower without spend fortune is major concern and first priority for every end user and racer.

Increasing RPM and add extra torque on any engine must consider first, is the cast iron block will absorb the extra load? Is the existing cast iron main caps will bear the double or triple instant impact force from cylinder explosion? Yes, we can change the main caps with billet steel material. We also may modify the two bolt main caps to a splayed four bolts main cap. There are too many ways to solve and improve the weakness of cast iron main cap problem. But all are expensive and required major modification.

The undersigned invented a simple and quick solution to solve this problem without any modification to the block.

A 1045 billet steel main girdle will do the job. The main cap girdle will cut and machine according to the dimension of bottom end of engine block. Ten boltholes are drilled on the girdle, which are at exact position as all 10 main bolts. The main cap girdle will mount and install on the top of all five main caps. An air gap should be maintained between top of main cap and cross frame of main cap girdle to avoid direct impact force from engine movement. The main cap girdle will install with high strength and longer studs for compensating the extra high of girdle.

When an engine has been modified with higher torque and RPM, the extra torque and instant impact force from explosion of a cylinder will be transmitted to the main bolts and the main caps. With the main cap girdle is installed, these extra l9oad will be transmitted and distributed to the entire solid main cap girdle evenly. Thence the main cap girdle will release these load back to the engine block. With the stronger 1045 billet steel material and allocation of impact force harmonic to the entire block will allow the main cap girdle to take torque movement more than 5 times than before.

There has no modification required for installation of the main cap girdle will bring benefit to all end user and save time for engine rebuilder.

### TECHNICAL DISCLOSURE OF BILLET STEEL MAIN GIRDLE FOR GENERAL MOTOR ENGINES

This main cap girdle is machined from a half of an inches thick 1045 billet steel. The main cap girdle consist four sides and three cross frames. The open spaces in between cross frames are for reducing weight and room for crankshaft movement.

Ten bolt holes are drilled on cross frames and ends from template with exactly location as main bolt on the engine block. A recess with 0.25″ deep on the cross frame between two bolts hole are machined with for obtaining an air gap between the main cap top and cross member. The present style is using insertion of thicker washers under main bolts to reach the air gap. It has been proved the thicker washer will create concentrated stress spot.

1. What I claim as my invention on the billet steel main cap girdle is the across recess space on the center of cross member:
This invention of Across Recess Space allows the billet steel main cap girdle directly place and seat on the top of main cap. The Recess Across Space will easy receive and maintain a reasonable gap for the convex top of main cap center without modify the main caps or insert washers under the main cap girdle. Any modification of main caps to suit a flat surface of Main Cap Girdle or insert extra washers under the main cap girdle will reduce the impact strength of the main cap for explosion of cylinders.
This invention allows the engine block and main caps stand heavier impact force and higher horsepower for high performance engine.
